(19) United States
(12) Patent Application Publication
(10) Pub. No.: US 2011/0303863 A1
(43) Pub. Date: Dec. 15, 2011

(54) COMBINED CHANGEOVER AND CONTROL VALVE

(76) Inventor: Thomas Middleton Semmes, Gladstone, OR (US)

(21) Appl. No.: 12/815,240

(22) Filed: Jun. 14, 2010

(51) Int. Cl. F16K 5/04

(52) U.S. Cl. 251/304

(57) ABSTRACT

A slim profile rotary control valve capable of independently modulating fluids into a single heat exchanger from two different and distinct systems that utilize the same type of heat transfer fluid. The valve is capable of monitoring both the supply and return fluid temperatures as well as the mass flow to enable the valve controller to optimize system's energy efficiency. It eliminates the use of multiple valves currently used in a conventional changeover system.

### BACKGROUND OF THE INVENTION

The present invention relates to a extremely versatile valve that can be uses in a plethora of HVAC situations including for changeover operation, heating and cooling modulation and energy monitoring and control. It provides system simplicity and energy efficiency.

Current HVAC systems employ multiple heat transfer surfaces in order to recover energy, preheat, heat, cool and dehumidify the supply airflow. Each of these heat transfer devices impart air friction, and in turn consumes fan energy. By using a single heat transfer surface for heat recovery, preheat, heat and cool, there is a reduction in the quantity of devices, air friction and resultant fan energy. The current invention results in a new type of valve which can allow multiple piping systems to share the usage of a common coil. The valve will allow hot and chilled water piping systems with the same type of fluid to utilize a single heat transfer device. The valve will combine numerous functions into a single valve which has not heretofore been done.

Henceforth, combined changeover and control valve would fulfill a long felt need in the HVAC industry. This new invention utilizes and combines known and new technologies in a unique and novel configuration to overcome the aforementioned problems and accomplish this. This new valve will allow buildings using hot and chilled water distribution systems to have improved efficiency especially if lowering the conventional return hot water temperature from 160 down to 100 deg F. In air handling units, fan energy is reduced as there is only a single coil providing both the heating and cooling functions.

### SUMMARY OF THE INVENTION

The general purpose of the present invention, which will be described subsequently in greater detail, is to provide a cylindrical rotary valve that is able to improve HVAC fan and heating efficiency and simplify syatems by reducing the quantity of valves, heat exchangers and controls.

It has many of the advantages mentioned heretofore and many novel features that result in a new and improved cylindrical valve which is not anticipated, rendered obvious, suggested, or even implied by any of the prior art, either alone or in any combination thereof.

In accordance with the invention, an object of the present invention is to provide an improved single valve capable of providing the supply and return fluid from one of two different systems to a single coil completely independently.

It is another object of this invention to provide an improved single valve capable of modulating both the heating and cooling functions of a single coil and that has a reduced profile.

It is a further object of this invention to provide a single valve capable of providing improved temperature control of heating and cooloing with a single control output.

It is still a further object of this invention to provide for a new valve that will allow buildings using hot and chilled water distribution systems to have improved efficiency.

It is yet a further object of this invention to provide an improved valve capable of modulating cooling and heating to a coil as well as having a supply pressure independent control and having the capability of measuring the fluid flowrate, in temperature and out temperature, thereby allowing energy to be calculated monitored and accumulated.

It is another object of this invention to promote energy recovery with four pipe water to water heat pumps.

It is yet another object of this invention to enable computer adjustment of minimum cool, maximum cool, minimum heat and maximum heat fluid flow and low energy.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is an isomeric perspective view of the valve and attached actuator showing the general arrangement of all components;

FIG. 2 is a top view of the valve;

FIG. 3 is a front view of the valve;

FIG. 4 is a side view of the valve;

FIG. 5 is a top view of the valve cylinder;

FIG. 6 is a front perspective view of the valve cylinder;

FIG. 7 is a to cross sectional view of the valve cylinder taken through the upper chamber;

FIG. 8 is a side view of the valve cylinder;

FIG. 9 is a side perspective view of the valve cylinder;

FIG. 10 is a front view of the valve cylinder;

FIG. 11 is a side view of the valve cylinder;

FIG. 12 is a top view of the valve body with the valve bonnet removed;

FIG. 13 is a front perspective view of the valve body with the valve bonnet removed;

FIG. 14 is a front view of the valve body with the valve bonnet removed;

FIG. 15 is a side view of the valve body with the valve bonnet removed;

FIG. 16 is a top perspective view of the valve body;

FIG. 17 is a top view of a characterization plate;

FIG. 18 is a top view of the valve packing at the top of the valve cylinder;

FIG. 19 is a side view of the thrust bearing;

FIG. 20 is a top cross sectional view of the valve with the valve cylinder rotated to the first system fluid position;

FIG. 21 is a top cross sectional view of the valve with the valve cylinder rotated to the second system fluid position;

FIG. 22 is a top perspective cutaway view of the valve with the valve cylinder rotated to the second system fluid position;

FIG. 23 is a top perspective cutaway view of the valve with the valve cylinder rotated to the first system fluid position;

FIG. 24 is a top view of the valve bonnet and packing gland assembly;

FIG. 25 is a front perspective view of the valve bonnet and packing gland assembly;

FIG. 26 is a front view of the valve bonnet and packing gland assembly;

FIG. 27 is a side perspective view of the valve bonnet and packing gland assembly;

FIG. 28 is a perspective view of the valve cylinder with the rotor incorporated into the second chamber;

FIG. 29 is a front view of the valve cylinder with the rotor incorporated into the second chamber;

FIG. 30 is a side view of the valve cylinder with the rotor incorporated into the second chamber;

FIG. 31 is a top view of the rotor;

FIG. 32 is a side perspective view of the rotor;

FIG. 33 is a side view of the rotor; and

FIG. 34 is a side perspective view of a rotated 90 degrees from FIG. 33 so the hall effector magnet is visible.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

The present invention is a cylindrical valve designed for system simplicity and energy efficiency in a plethora of HVAC situations. It sees its full potential when used for changeover operation, heating and cooling modulation. Here cold and hot fluid media from two separate and distinct fluid media systems may be each alternately introduced into a single heat exchanger and controlled/monitored with the use of a single valve.

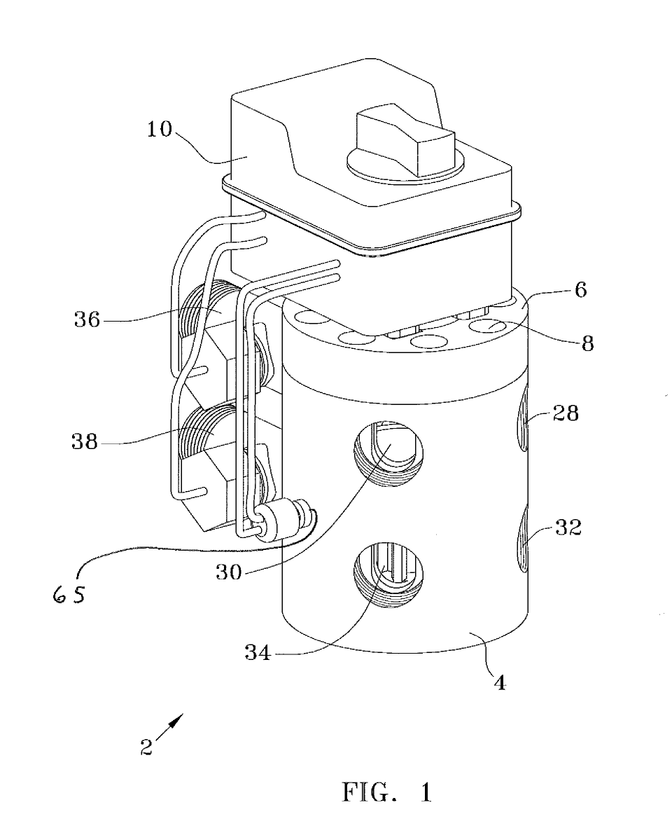

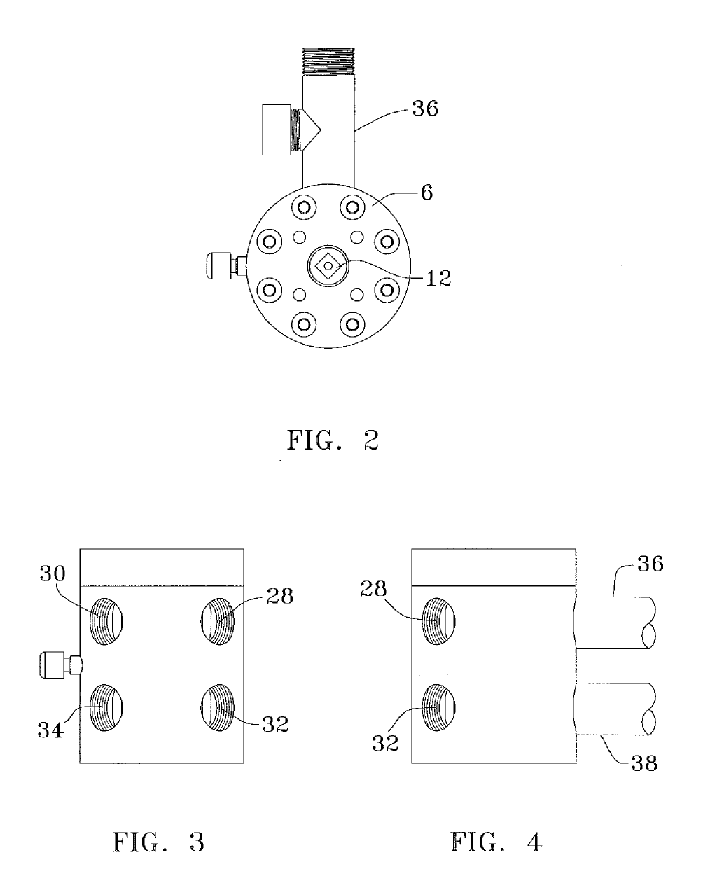

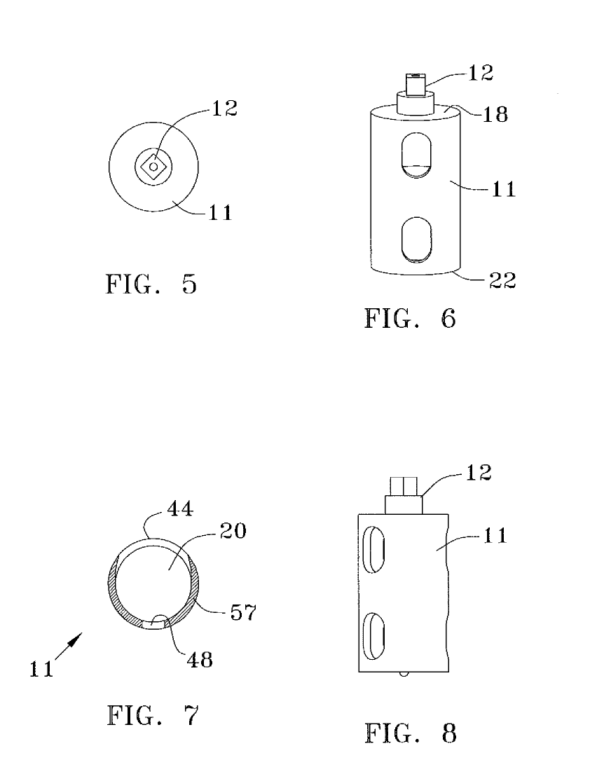

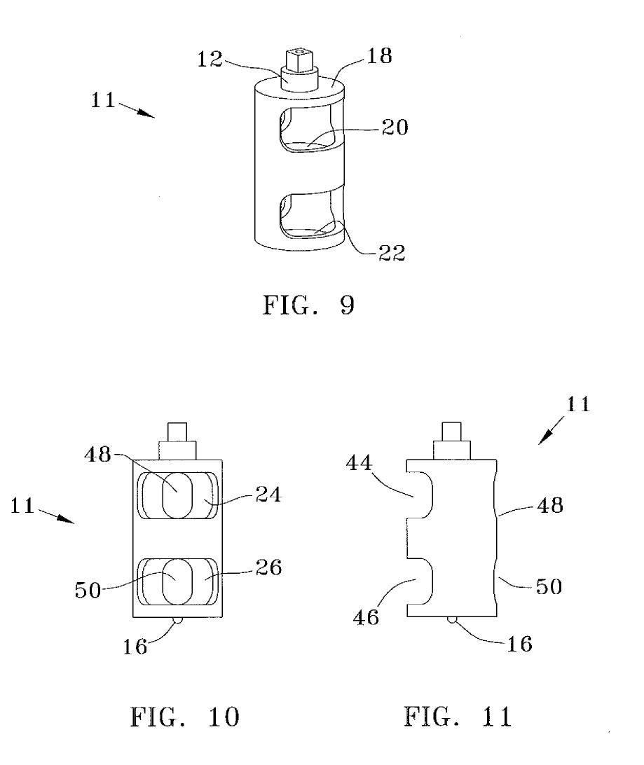

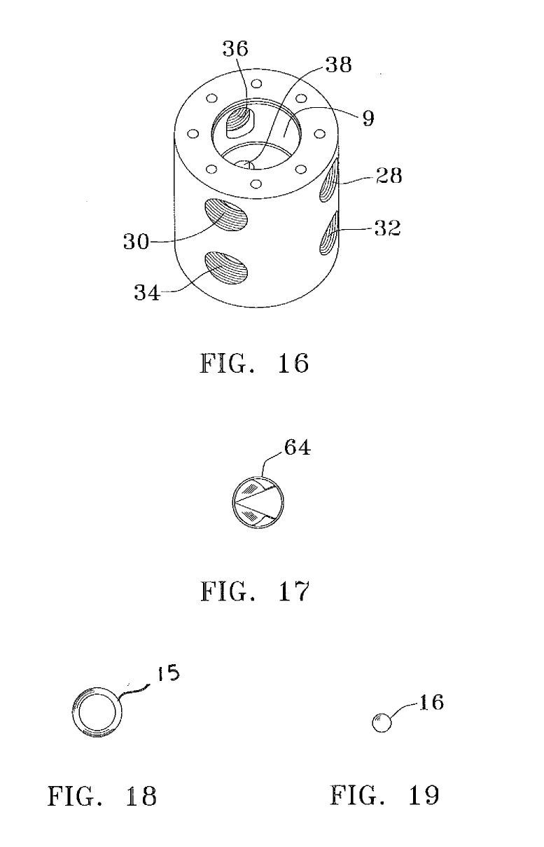

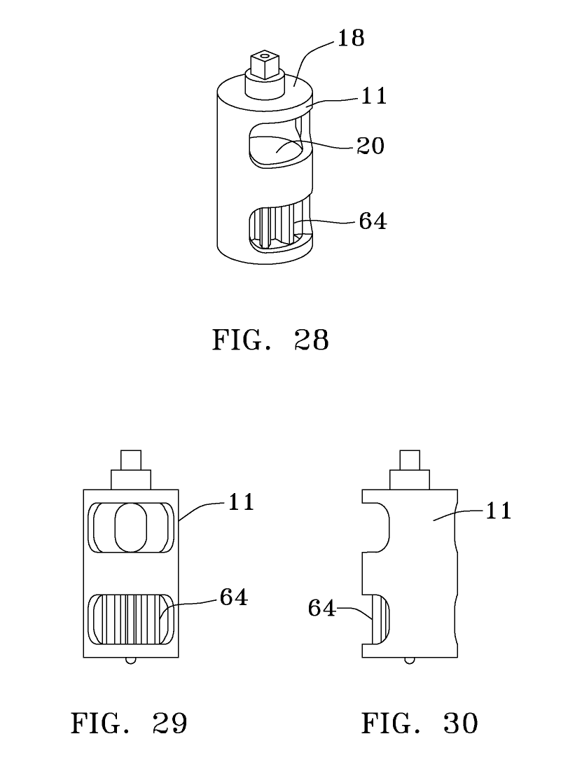

Looking at FIG. 1 the exterior general arrangement of a power operated rotary valve 2 can be seen. The valve body 4 is a monolithic body with a stopped central bore formed therein about its longitudinal axis to matingly engage the valve cylinder 11. Rotationally housed inside this central bore 9 (FIGS. 13 and 16) is the valve cylinder 11 (FIGS. 8-11). This valve cylinder 11 has the physical configuration of a right circular cylinder and has three parallel round faces that enclose the valve cylinder 11 at either end and segment it into a first valve chamber 24 and second valve chamber 26. The first (upper) face 18, second (central) face 20 and third (lower) face 22 can best be seen in FIG. 9. These valve faces may be formed as part of a unitary cylinder as illustrated in FIG. 9 or they may be fabricated as separate first (upper) face disk 18′, second (central) face disk 20′ and third (lower) face disk 22′ that are seen in FIGS. 28 to 30. The first and third separate face disks may or may not be affixed to the valve cylinder 11 as the assembly is a close tolerance fit that is rigidly constrained within the valve body 11 by the valve bonnet 6. FIG. 7 shows a cross sectional view of the valve cylinder 11 sectioned through the first valve chamber 24. In the preferred embodiment the central face 20 bisects the valve cylinder 11 such that the two chambers are of equal volume, although this need not be the case. Extending normally from the upper face 18 is a valve stem 12 having a circular and a square portion. (FIGS. 5 and 6)

A thrust bearing 16 (FIG. 19) resides at the midpoint of the bottom surface of the valve cylinder 11 so as to stabilize the valve cylinder 11 within the valve body 4 and minimize the rotational friction during valve manipulation. There may be a detent formed in the bottom of the valve body to accept the thrust bearing 16, although this detail is not illustrated as such a design is well known in the industry. About the periphery of the valve body 4 are two substantially similar and parallel series of heat transfer media supply and return ports formed through the walls of the valve body 4. Although the ports are depicted as having internal threads, a smooth walled embodiment may be utilized when it is desirable to solder in the piping connections. threaded

FIGS. 3, 4 and 14 illustrates the first medium (lower) supply port 32 and the second medium (lower) supply port 34 that provide the fluid path into the first valve chamber 26 and the first medium (upper) return port 30 and the second medium (upper) return port 28 that provide the fluid path into the second valve chamber 24. There is also a heat exchanger supply outlet 38 and a heat exchanger return inlet 36 formed through the walls of the valve body 4.

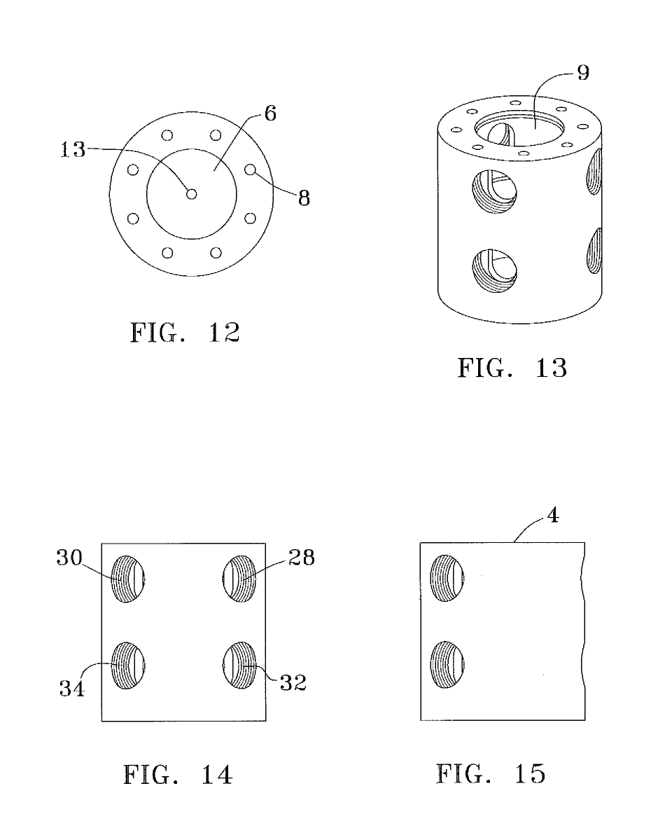

A bonnet 6 is mechanically affixed to said valve body by fasteners 8 (FIG. 12) so as to form a fluid seal about the top of the valve body 4. Appropriate seals may be incorporated between the exterior surfaces of these parts as is well known by one skilled in the art. Between the upper face 18 of valve cylinder 11 and the inner side of the bonnet 6 may reside a packing seal 15 as depicted in FIG. 18. In the preferred embodiment the bonnet 6 is generally planar and upon which a valve actuator 10 is mounted. It is known that in different embodiments the bonnet 6 may have an additional length platform extending therefrom to facilitate the attachment of different actuators to the valve. The bonnet 6 has a stem orifice 13 there through that the valve stem 12 passes. The packing seal 15 encircles this valvew stem 12. Directly atop the bonnet 6 resides the packing gland assembly 14 with the midpoint of its central orifice aligned with that of the bonnet's stem orifice 13 such that the valve stem 12 may also pass through it. The packing gland assembly 14 is a conventional gland seal used around the circular section of the valve stem 12 the point it exits the valve body 4. It is the most common method for preventing fluid leakage while still allowing the valve stem 12 to rotate and is well known by one skilled in the field of art. Generally, the seal itself is provided by packing rings, or a square cross-sectioned rope, made of greased flax, which is packed or wound tightly around the valve stem 12, and compressed in place with a threaded nut and spacer. The packing gland may also be fitted with an opening for periodic insertion of grease between the rings, and sometimes with a small grease reservoir.

The top square section of the valve stem 12 fits into a matingly engagable section of the valve actuator 10. The valve actuator 10 is a commercially available rotary actuator that operates through an approximately 90 degree rotation with additional adjustment for rotary motion at each extent of its rotation travel.

Looking in detail at the valve cylinder 11 (FIGS. 9 to 11) it can be seen that the first (supply) valve chamber 26 and the second (return) valve chamber 24 each have two generally elliptical cylinder ports. The larger of the two cylinder ports are the heat exchanger supply port 46 and the heat exchanger return port 44 (FIG. 11). The smaller of the two cylinder ports are the supply inlet (crossover) port 50 and the return outlet (crossover) port 48.

Key to the understanding of the operation of this valve is that for changeover operation in the heating or cooling of a heat exchanger either the first heat transfer medium (e.g. cold water) or the second heat transfer medium (e.g. hot water) independently and alone will be circulated through the heat exchanger. These two heat transfer media come from their own independent systems (e.g. chilled water or hot water systems) but contain the same type of heat transfer fluid. Generally, to accomplish this switching of heat transfer media with the prior art technology required multiple valves, actuators and controllers.

For the purposes of clarity in this explanation and to prevent confusion, only the heat transfer medium supply operation is discussed. The heat transfer medium return operation is not discussed but operation of the supply side of the first (supply) valve chamber 26 is identical to that of the second (return) valve chamber 24 as all supply ports in the valve body 4 and the valve cylinder 11 are identical with the return ports and are symmetrical about the plane of the central face 20.

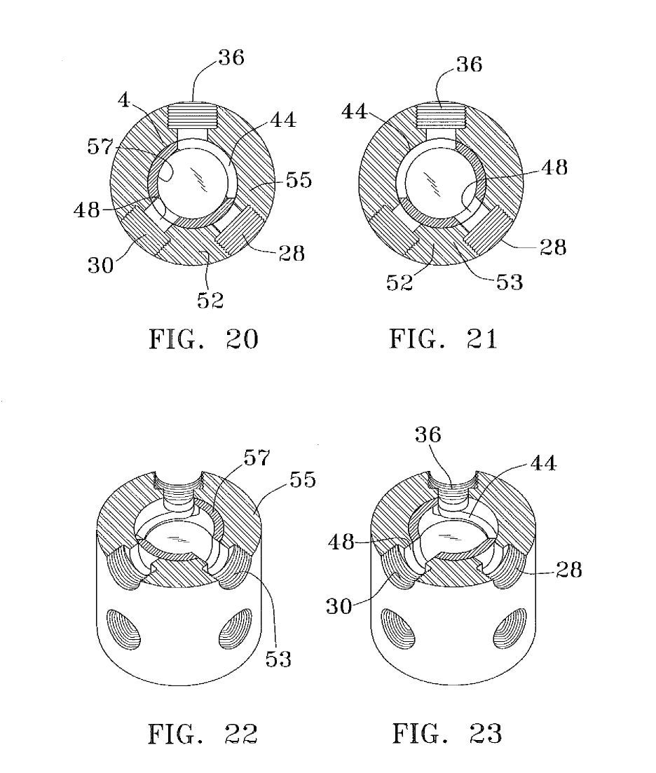

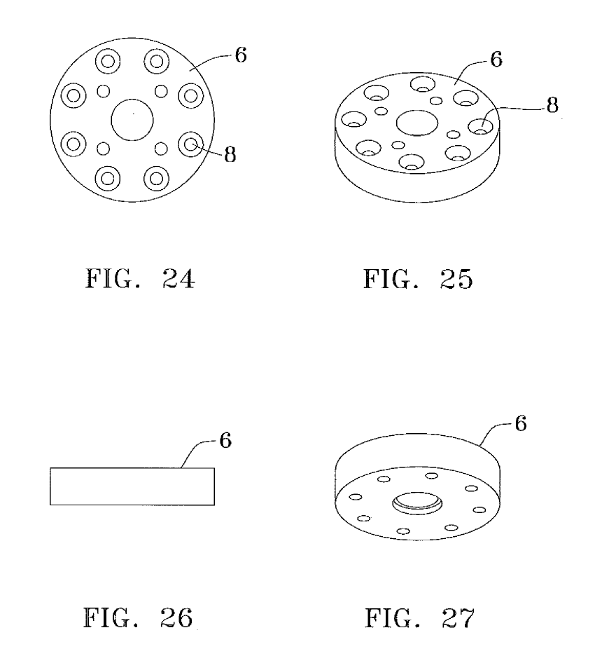

In operation, it is to be noted that the valve cylinder 12 only rotates clockwise and counterclockwise approximately 90 degrees within the valve body 4 (plus or minus 5 degrees on either side.) Looking at FIGS. 20 to 23 with respect to the first valve chamber 24, it can be seen that within this approximately 90 degree cylinder rotation constraint the heat exchanger supply port 44 is always aligned with the heat exchanger supply 38 of the valve body 4 regardless of whether the supply port 48 is aligned with the second medium (lower) supply port 34 (FIGS. 20 and 23), aligned with the first medium (lower) supply port 32 (FIGS. 21 and 22), closed by alignment with the closed section of the valve body wall 52 or is anywhere in between. Thus heat exchanger supply port 44 is fully open at all times.

For this design to work it is critical that the width of the second medium (lower) supply port 34 and the first medium (lower) supply port 32 do not exceed ⅓ of the number of degrees of rotation of the valve cylinder 11 within the valve body 4. (Here that would be 30 degrees) and that they reside apart at least ⅓ of the number of degrees of rotation of the valve cylinder 11. (Again here that would be 30 degrees.) It is also critical that the width of heat exchanger supply port 44 is at a minimum the 4/3 the number of degrees of rotation of the valve cylinder 11 in the valve body 4. (Here that would be 120 degrees) and that the heat exchanger supply inlet 36 resides more than the number of degrees of rotation of the valve cylinder 11 in the valve body 4 away from either the first medium supply port 28 or the second medium supply port 30. (Here that would be 90 degrees.) The supply port 48 of the valve cylinder 11 is sized the same as both the second medium (lower) supply port 34 and the first medium (lower) supply port 32 of the valve body 4. In this way the opening of the supply crossover port 48 may be rotationally positioned between the second medium (lower) supply port 34 and the first medium (lower) supply port 32 so as to reside directly adjacent the closed section of the valve body wall 52 so as to close off the flow from either of the heat transfer media through the valve cylinder 11 and into the heat exchanger. If a throttled flow is desired through the valve 2 the valve cylinder 11 is rotated to a position where the supply port 48 does not totally align with the first or second medium supply ports 32 and 34. When a full flow of either of the heat transfer media is desired the supply port 48 is completely aligned with either of the first or second medium supply ports 32 or 34. When changeover between the two different heat transfer media is required the valve cylinder 11 must be rotated through a position wherein the supply port is closed. This prevents any unwanted intermixing of the two heat transfer mediums.

It is to be noted that the width of 48 is less than the spacing between the adjacent edges of 34 and 32 (which is the closed section of the valve body wall 52.) The second valve chamber 26 functions in a similar fashion. With this design, within a 90 degree rotation of the valve cylinder 12 within the valve body 4 either the first heat transfer fluid or the second heat transfer fluid may be admitted to the heat exchanger.

Nominal Valve Body & Cylinder Dimensions
For a ¼ Turn (90°) Valve*

| | Angular | |
|---|---|---|
| Dimensioned Item | Width** | Formulae |
| width of opening of supply ports | max 45° | max up to ½ |
| 32 & 34 and return ports 28 & 30 | | the degrees of cylinder |
| (valve body) | | rotation |
| width of opening of supply | max 45° | max up to ½ |
| crossover port 48 and return | | the degrees of cylinder |
| crossover port 50 (valve cylinder) | | rotation |
| space 53 between adjacent supply | max 45° | max up to ½ |
| ports 28 & 30 and adjacent return | | the degrees of cylinder |
| ports 32 & 34 (valve body) | | rotation |
| width of opening of heat | min 135° | min 3/2 the number of |
| exchanger supply port 44 or heat | | degrees of rotation of |
| exchanger return port 46(valve | | the valve cylinder+ |
| cylinder) | | |
| width of opening of heat | min 45° | min up to ½ the |
| exchanger supply inlet 36 or heat | | number of degrees of |
| exchanger return outlet 38(valve | | rotation of the valve |
| body) | | cylinder |
| space 55 between heat exchanger | min 90° | min up to the number |
| supply inlet 36 and adjacent | | of degrees of rotation of |
| supply ports 28 & 30 or | | the valve cylinder |
| space between heat exchanger | | |
| return outlet 38 and adjacent | | |
| return ports 32 & 34 (valve body) | | |
| space 57 between heat exchanger | min 90° | min up to the number |
| supply port 44 and supply | | of degrees of rotation of |
| crossover port 48 or heat | | the valve cylinder |
| exchanger return port 46 and | | |
| return crossover port 50 | | |
| (valve cylinder) | | |

*Reference FIGS. 22 and 23.
**Taken from midpoint of the cylinder 11.

The above dimensions are minimum and maximum design purposes only. There must be additional spacing for overlap of the valve body walls beyond the limits of the openings in 44, 46, 48 and 50 to ensure that there is a complete seal formed between these parts as required so that there can be no unwanted bleed over or bypass flow between any of the valve body openings. This necessitates that the nominal angular dimensions of the valve body and valve cylinder of the previous chart are modified to ensure proper operation. The following chart details the dimensions for the preferred embodiment valve.

Valve Body & Cylinder Dimensions
For Preferred Embodiment(90°)Valve

| | Angular Width |
|---|---|
| Dimensioned Item | & Tolerance |
| width of opening of supply ports 32 & 34 and | 42° +/− 2° |
| return ports 28 & 30 (valve body) | |
| width of opening of supply port 50 and return port | 42° +/− 2° |
| 48 (valve cylinder) | |
| space 53 between adjacent supply ports 32 & 34 | 48° +/− 2° |
| and adjacent return ports 28 & 30 (valve body) | |
| width of opening of heat exchanger supply port 46 | 135° +/− 2° |
| or heat exchanger return port 44(valve cylinder) | |
| width of opening of heat exchanger supply inlet 38 | 42° +/− 2° |
| or heat exchanger return outlet 36(valve body) | |
| space 55 between heat exchanger supply inlet 38 | 92° +/− 2° |
| and adjacent supply ports 32 & 34 or | |
| space between heat exchanger return outlet 36 and | |
| adjacent return ports 28 & 30 (valve body) | |
| space 57 between heat exchanger supply port 46 | 92° +/− 2° |
| and supply port 50 or heat exchanger return port | |
| 44 and return crossover port 48 (valve cylinder) | |

It is to be noted that the general shapes of all openings in the valve cylinder and valve body have been optimized to minimize the overall size of the valve. Looking at FIGS. 6 and 16 it can be seen that all supply and return ports 28, 32, 32 and 34 as well as the crossover ports 48 and 50 are generally elliptical in shape or a modified version of a generally elliptical shape. In this manner the valve cylinder diameter of the valve 2 may be minimized.

To explain in terms of operation the system may only require flow through a nominal ½ inch schedule 40 pipe. This has an ID of 0.62 inches and a cross sectional area of 0.30 square inches. Assuming round ports, this would require the physical width of the ports 48 and 50 to be approximately 0.62 inches. This 0.62 inches would represent 45° of the circumference of the outside of the valve cylinder which would be 4.98 inches and would equal a valve cylinder of approximately 1.6 inches in diameter.

If a nominal ¾ inch pipe were used with an ID of 0.82 inches and a cross sectional area of 0.53 square inches this would allow the ports 48 and 50 to be made into a traditional elliptical shape and heightened from 0.62 inches to 0.82 inches and narrowed from 0.62 inches to 0.46 inches and still retain the same cross sectional area of the previous example of 0.30 square inches. This 0.46 inches would represent 45° of the circumference of the outside of the valve cylinder which would be 3.68 inches and would equal a valve cylinder of approximately 1.17 inches in diameter. This represents approximately a 27% decrease in size.

Looking at the configuration of the ports in FIG. 10 it can be see that the preferred embodiment uses a modified ellipse shape that falls somewhere between a rectangle and an ellipse. This allows the opening to be narrowed even further and allows the preferred embodiment to achieve greater than 27% reduction in valve diameter.

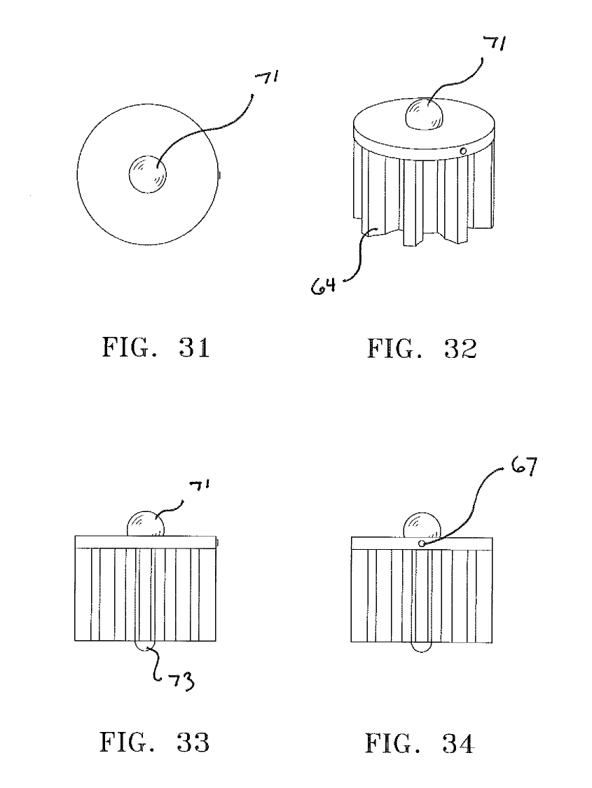

Looking at FIGS. 1, 13 and 28-30 the measurement controls of the valve 2 can best be seen. Thermocouple taps 60 extend through the heat exchanger return inlet 36 and the heat exchanger supply outlet 38 on the valve body 4. The sensing ends of thermocouples for temperature monitoring are housed in these taps and relay temperature signals to instrumentation for valve control or indication. At the juncture of the valve body fittings and the supply inlets 32 and 34 a flow restricting orifice or characterization disk 64 (FIG. 17) is utilized to customize the flow response to match a more linear heat transfer result. A rotating vane (rotor) 64 shall provide positive displacement metering when placed in one of the valve cylinder chambers 24 or 26. As is well known in the art there would be an electrical pulse transmitter (pickup) 65 mounted on the outside of the valve body 4 to receive rotation pulses from the passing magnet 67 from the spinning rotor and to relay them to a controller or indicator that may be mounted in the valve actuator 10. This type of hall effector sensing device is well known in the art of instrumentation and control. The present invention lends itself to the inclusion of a positive displacement metering rotor 64 inside the valve cylinder itself. Looking at FIGS. 31 to 34 the general assembly of this flow measuring device can best be seen. For precise flow measurement it is desirable to have a positive displacement vane or rotor 64 that offers minimal resistance through the use of an upper bearing 71 and a lower bearing 73 that act to stabilize the rotor and allow for low friction rotation. An efficient and economical design uses steel balls that reside partially in a set of detents formed in the central face 20 and the lower face 22.

In assembly it is known that this valve will be a close tolerance valve and that the tightening of the bonnet 6 onto the valve body 4 when the valve cylinder 11, valve faces and all associated bearings are installed, will serve to compress the assembly and load the bearings so as to stabilize the internal structure of the unit.

There are numerous features and benefits to the aforementioned combined changeover and control valve such as: it replaces four valves in the conventional changeover configuration; it needs only one control output, instead of two or three; it leads to fewer components pipe and instrumentation to mount; water balancing valves are eliminated; It offers the speed in shut off like a ball valve with 45 degree isolation; it acts like a ball valve with the resultant low pressure drop making it ideal for straight line flow with minimal restrictions; it acts like a globe valve with a proportional response to position with larger valve ports, strainers are no longer needed to catch debris; larger valve ports and a simpler water path reduces water friction, and lowers pump energy; water temperature and flow sensing built into the valve itself; the valve is now truly pressure independent of supply pressure fluctuations; the valve can now be modulated to match Btu energy requirements; and the amount of heating Btu and cooling Btu consumption is now measurable at the air handler via computer.

Although depicted with two separate chambers in the valve cylinder, it is known that three or more valve cylinder chambers may be utilized with the attendant inlet and outlet connections in an alternate embodiment of the present invention.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. For example while this specification discloses a 90 degree rotation valve it is known that the valve cylinder must rotate within a limited number of degrees in the valve body, but that with modifications it need not be limited to a 90 degree rotation.

It is important, therefore, that the claims be regarded as including such equivalent constructions insofar as they do not depart from the spirit and scope of the present invention.

Having thus described the invention, what is claimed as new and desired to be secured by Letters Patent is as follows:

1. A rotary valve comprised of:
a valve body having a stopped internal bore and an open top;
a bonnet plate that is mechanically affixed to said open top and has a first valve stem orifice formed there through;
a packing gland assembly with a second valve stem orifice formed there through that is mechanically affixed to said bonnet such that said first and second valve stem orifices are aligned,
a valve cylinder matingly configured to and rotatably housed within said internal bore, having a valve stem extending normally there from that extends through said aligned stem orifices;
a valve actuator adapted to receive said valve stem and rotate said valve cylinder in said valve body within a limited number of degrees.

2. The rotary valve of claim 1 wherein said valve cylinder is divided into a first valve chamber and a second valve chamber which are substantially identical.

3. The rotary valve of claim 2 wherein said valve cylinder has a right cylinder configuration with a top, middle and bottom circular and parallel face plates wherein said top and bottom face plates enclose said valve cylinder and said middle face plate bisects the cylinder to form said first and second valve chambers.

4. The rotary valve of claim 3 wherein
said valve body has at least one first heat transfer medium supply port, and at least one second heat transfer medium supply port and at least one first heat transfer medium return port and at least one second heat transfer medium return port, and a heat exchanger supply inlet and a heat exchanger return outlet; and
wherein said first valve chamber has a heat exchanger supply port and supply crossover port and said second valve chamber has a heat exchanger return port and return crossover port; and
wherein said first and second heat transfer medium supply ports and said heat exchanger supply inlet of said valve body and said heat exchanger supply port and said supply crossover port of said valve cylinder all have midpoints that align about a common plane that bisects said first valve chamber and resides parallel to all said face plates; and
wherein said first and second heat transfer medium return ports and said heat exchanger return outlet of said valve body and said heat exchanger return port and said return crossover port of said valve cylinder all have midpoints that align about a common plane that bisects said second valve chamber and resides parallel to all said face plates.

5. The rotary valve of claim 4 wherein said valve cylinder has a thrust bearing centrally located on an exterior surface of said bottom face plate so as to reside between said valve cylinder and said valve body.

6. The rotary valve of claim 5 wherein said first heat transfer medium supply port and said supply crossover port align simultaneously with the alignment of said a heat exchanger supply inlet and said heat exchanger supply port to enable the fluid flow to a heat exchanger through the first chamber at the same time that said first heat transfer medium return port and said return crossover port align simultaneously with the alignment of said a heat exchanger return outlet and said heat exchanger return port to enable the fluid flow from a heat exchanger through the second chamber.

7. The rotary valve of claim 5 wherein said second heat transfer medium supply port and said supply crossover port align simultaneously with the alignment of said a heat exchanger supply inlet and said heat exchanger supply port to enable the fluid flow to a heat exchanger through the first chamber at the same time that said second heat transfer medium return port and said return crossover port align simultaneously with the alignment of said a heat exchanger return outlet and said heat exchanger return port to enable the fluid flow from a heat exchanger through the second chamber.

8. The rotary valve of claim 1 wherein said valve bonnet plate is generally planar and extends beyond said valve body so as to create a platform for attachment of a valve controller or mounting of said rotary valve.

9. The rotary valve of claim 1 further comprising a positive displacement rotor rotationally mounted inside a valve cylinder chamber.

10. The rotary valve of claim 8 further comprising a positive displacement rotor rotationally mounted inside a valve cylinder chamber for positive displacement flow measurement.

11. The rotary valve of claim 1 where said limited number of degrees said valve cylinder can be rotated within said valve body is approximately 90.

12. The rotary valve of claim 6 where said limited number of degrees said valve cylinder can be rotated within said valve body is approximately 90.

13. The rotary valve of claim 7 where said limited number of degrees said valve cylinder can be rotated within said valve body is approximately 90.
